(19) United States
(12) Patent Application Publication
(10) Pub. No.: US 2017/0225995 A1
(43) Pub. Date: Aug. 10, 2017

(54) METHOD FOR MANUFACTURING TEMPERED GLASS

(71) Applicant: Corning Precision Materials Co., Ltd., Chungcheongnam-do (KR)

(72) Inventors: Kyung Min Yoon, Chungcheongnam-do (KR); Jin Soo An, Chungcheongnam-do (KR); Ji Hoon Lee, Chungcheongnam-do (KR); Ho Sam Choi, Chungcheongnam-do (KR)

(73) Assignee: Corning Precision Materials Co., Ltd., Chungcheongnam-do (KR)

(21) Appl. No.: 15/301,886

(22) PCT Filed: Jan. 22, 2015
(86) PCT No.: PCT/KR2015/000663

§ 371 Date: Oct. 4, 2016

(30) Foreign Application Priority Data
Feb. 14, 2014 (KR) 10-2014-0017236

(51) Int. Cl. C03B 27/02; C03C 23/00; C03B 27/012

(52) U.S. Cl. CPC C03B 27/02; C03B 27/012; C03C 23/008

(57) ABSTRACT

The present invention relates to a method for manufacturing tempered glass and, more specifically, to a method for manufacturing alkali-free glass which has the thickness of 2.0 mm or less into tempered glass by means of heat treatment and surface treatment using fluosilicic acid. To this end, the present invention provides a method for manufacturing tempered glass, the method comprising: a preparation step for preparing alkali-free glass; a surface treatment step for surface-treating the alkali-free glass by means of a surface treatment solution comprising fluosilicic acid and thereby generating on the surface of the alkali-free glass a porous SiO₂-rich layer of which the coefficient of thermal expansion (CTE) is smaller than the CTE of the inner part of the alkali-free glass; and a heat treatment step for heat-treating the alkali-free glass that has been surface-treated and thereby generating compressive stress on the surface of the alkali-free glass.

### TECHNICAL FIELD

The present disclosure relates to a method of manufacturing toughened glass, and more particularly, to a method of manufacturing toughened glass from alkali-free glass having a thickness of 2.0 mm or less through carrying out a surface treatment using fluorosilicic acid and a heat treatment.

### BACKGROUND ART

At present, glass materials are used in a range of industrial fields, specifically, as the covers of photovoltaic cells, in flat displays, such as thin-film-transistor liquid crystal displays (TFT-LCDs) or organic light-emitting devices, in a variety of mobile electronic devices, and so on.

Recently, in response to the trend for electronic devices to have slim, compact profiles, glass materials have also been required to be lightweight and thin. To compensate for the resultant structural fragility of such glass materials, a variety of glass-toughening methods have been researched.

A thermal toughening method is most typical among such glass-toughening methods. The thermal toughening method utilizes a technology of generating compressive stress in the surface of glass by rapidly cooling the surface of the glass after heating the glass to a temperature close to the softening point thereof, typically, a temperature ranging from 600° C. to 800° C., thereby toughening the glass. The thermal toughening method is a method able to easily increase the strength of glass at relatively low cost. When the surface of hot glass is rapidly cooled, the glass surface has a longer interatomic distance than the inner portion of the glass that is slowly cooled. The difference between the interatomic distances causes stress, thereby generating compressive stress in the surface of the glass. The compressive stress generated in the glass surface as described above restricts the growth of cracks formed in the glass surface, thereby toughening the glass. When the difference in temperature between the surface and the inner portion of the glass is greater, the difference in the interatomic distance between the surface and the inner portion of the glass is greater. Thus, higher compressive force is formed, whereby the glass can be more effectively toughened. However, when the thickness of glass is equal to or less than 2.5 mm, it is difficult to obtain a significant difference in temperatures between the surface and the inner portion of the glass by rapidly cooling the surface of the glass. Thus, a sufficient amount of compressive stress cannot be generated, thereby making it difficult to realize the level of toughening required. That is, thermal toughening may be inappropriate for use in glass materials used in electronic devices or the like, in which a thin glass plate having a thickness of about 1.0 mm or less is used to reduce weight.

Chemical toughening is generally used to toughen thin glass plates. Chemical toughening is a method of toughening glass by heating a glass plate to a temperature close to a transition temperature thereof, typically, a temperature ranging from 350° C. to 450° C. and then generating compressive stress in the surface of the glass plate through ion exchange. Such chemical toughening is performed by dipping glass containing an alkali, such as Na+, into a molten salt, such as KNO₃. Then, Na+ ions present in the glass are substituted with K+ ions that are larger than the Na+ ions, thereby generating compressive stress in the surface of the glass. Although chemical toughening can be used regardless of the thickness of glass, it is difficult to apply chemical toughening to glass that does not contain an alkali ion. For example, when LCD substrates are formed from glass, alkali-free glass may be used to prevent alkali ions from moving outwardly toward LCD circuits. In this case, chemical toughening cannot be used.

Recently, due to the rapid development and distribution of LCDs used in mobile devices and so on, the need to strengthen LCD glass substrates has come to prominence. However, none of the conventional methods, such as thermal toughening and chemical toughening, can be used to toughen such alkali-free thin glass plates, which is problematic.

### PRIOR ART DOCUMENT

Japanese Unexamined Patent Publication No. 2003-036522 (Feb. 7, 2003)

### DISCLOSURE

### Technical Problem

Accordingly, the present disclosure has been made in consideration of the above problems occurring in the related art, and the present disclosure is intended to propose a method of manufacturing toughened glass from alkali-free glass having a thickness of 2.0 mm or less through a surface treatment using fluorosilicic acid and a heat treatment.

### Technical Solution

According to an aspect of the present disclosure, a method of manufacturing toughened glass may include: preparing alkali-free glass; forming a porous SiO₂ rich layer in a surface portion of the alkali-free glass by surface-treating the alkali-free glass using a surface treatment solution including fluorosilicic acid, such that a coefficient of thermal expansion of the porous SiO₂ rich layer is lower than a coefficient of thermal expansion of an inner portion of the alkali-free glass; and generating compressive stress in a surface of the alkali-free glass by heat-treating the surface-treated alkali-free glass.

Here, surface-treating the alkali-free glass may include extracting positive ions other than Si from the alkali-free glass.

In addition, the alkali-free glass may be a thin alkali-free glass plate having a thickness of 2.0 mm or less.

The surface treatment solution may be prepared by supersaturating a 10 wt % to 50 wt % fluorosilicic acid water solution with SiO₂.

KF or boric acid may be added to the surface treatment solution.

Surface-treating the alkali-free glass may be performed while controlling the temperature of the surface treatment solution within a range of room temperature to 55° C.

Heat-treating the surface-treated alkali-free glass may be performed at a temperature within a range of 500° C. to 1300° C.

Preparing the alkali-free glass may include cleaning the surface of the alkali-free glass using an HF water solution.

### Advantageous Effects

According to the present disclosure, it is possible to manufacture a toughened glass plate from a thin alkali-free glass plate having a thickness of 2.0 mm or less that is difficult to toughen using a conventional thermal toughening method or a conventional chemical toughening method. Specifically, a porous SiO₂ rich layer, the CTE of which is lower than a CTE of an inner portion of the alkali-free glass plate, is formed in a surface portion of the alkali-free glass plate through surface-treating the alkali-free glass plate using fluorosilicic acid, and then compressive stress is generated in the surface of the alkali-free glass plate based on the difference between the CTE of the surface and the CTE of the inner portion of the alkali-free glass plate through heat-treating and cooling the alkali-free glass plate.

In addition, according to the present disclosure, it is possible to toughen the thin alkali-free glass plate without degradations in the optical characteristics thereof.

### DESCRIPTION OF DRAWINGS

FIG. 1 is scanning electron microscopy (SEM) images of the cross-section and the surface of a thin alkali-free glass plate after a surface treatment according to a method of manufacturing toughened glass in an exemplary embodiment;

FIG. 2 is graphs displaying secondary ion mass spectroscopy (SIMS) analysis results obtained from the surfaces of thin alkali-free glass plates after a surface treatment according to a method of manufacturing toughened glass in an exemplary embodiment; and

FIG. 3 is SEM images of a cross-section and the surface of a thin alkali-free glass plate after heat treatment according to a method of manufacturing toughened glass in an exemplary embodiment.

### MODE FOR INVENTION

Hereinafter, reference will be made in detail to a method of manufacturing toughened glass according to some exemplary embodiments in conjunction with the accompanying drawings.

In the following description, detailed descriptions of known functions and components will be omitted in the case that the subject matter of the present disclosure is rendered unclear by the inclusion thereof.

The method of manufacturing toughened glass according to an exemplary embodiment includes a preparation step, a surface treatment step, and a heat treatment step.

First, the preparation step is a step of preparing alkali-free glass to be toughened. The alkali-free glass used herein may be, for example, borosilicate glass used in the covers of photovoltaic cells, in flat displays, such as thin-film-transistor liquid crystal displays (TFT-LCDs), in plasma display panels (PDPs), in organic electroluminescent (EL) devices, a variety of mobile electronic devices, and so on. The alkali-free glass may be a thin glass plate having a thickness of 2.0 mm or less.

In the preparation step, the surface of the alkali-free glass may be cleaned using a hydrogen fluoride (HF) solution to remove an oxide film naturally formed on the surface of the alkali-free glass.

The subsequent surface treatment step is a step of treating the surface of the alkali-free glass using a surface treatment solution containing fluorosilicic acid. The surface treatment step consequently forms a porous SiO₂ rich layer in a surface portion of the alkali-free glass, the coefficient of thermal expansion (CTE) of the porous SiO₂ rich layer being lower than the CTE of an inner portion of the alkali-free glass.

The SiO₂ rich layer may be formed by dipping the alkali-free glass into a surface treatment solution prepared by supersaturating a 10 wt % to 50 wt % fluorosilicic acid (H₂SiF₆) water solution with SiO₂. KF or boric acid may be added to the surface treatment solution to adjust the rate at which the SiO₂ rich layer is formed in the surface portion of the alkali-free glass.

The temperature at which the surface treatment is performed may be controlled to range from room temperature to 55° C., whereby the rate at which the SiO₂ rich layer is formed can be controlled. Here, the period of time during which the surface treatment is performed may vary depending on the thickness of the porous SiO₂ rich layer to be formed in the surface portion of the alkali-free glass and the composition of the alkali-free glass.

When the alkali-free glass is treated using the surface treatment solution containing fluorosilicic acid as a major ingredient as described above, a number of microscale pores having a size of several hundred nanometers or less are formed in the surface portion of the alkali-free glass. The number of microscale pores are dispersed in the surface portion of the alkali-free glass, thereby allowing the porous SiO₂ rich layer to be formed. The SiO₂ rich layer including the number of microscale pores is formed as a result of the extraction of positive ions other than Si from the alkali-free glass during the surface treatment performed on the alkali-free glass. The CTE of the SiO₂ rich layer is lower than the inner portion of the alkali-free glass.

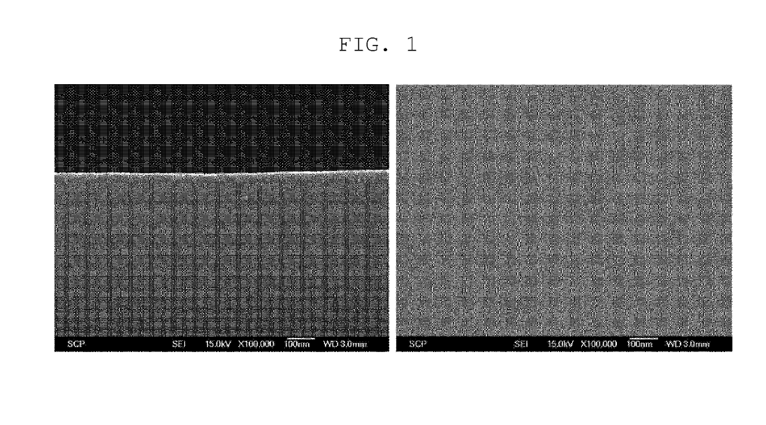

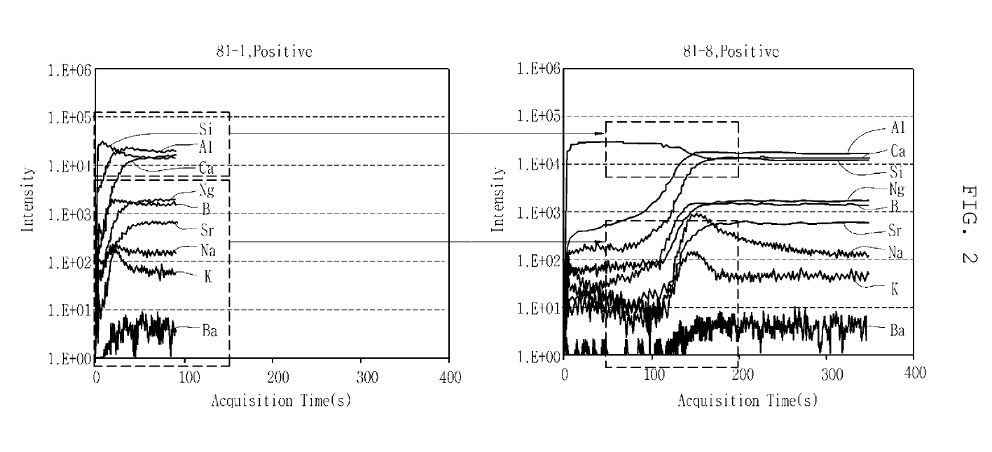

To determine whether or not the porous SiO₂ rich layer was formed in the surface portion of the alkali-free glass, a naturally formed oxide film and contaminant were removed from the alkali-free glass by cleaning the alkali-free glass using a 2 wt % HF solution for two minutes and then the alkali-free glass was placed to react with a 18 wt % fluorosilicic acid water solution, supersaturated with SiO₂. Here, the temperature of the fluorosilicic acid water solution was controlled to be 35° C., and the reaction was performed for 15 minutes. After the reaction was completed, the surface of the alkali-free glass was analyzed using a scanning electron microscope (SEM) and a secondary ion mass spectroscope (SIMS), and the results are presented in FIG. 1 and FIG. 2.

Referring to FIG. 1, it can be visually appreciated that, when the alkali-free glass reacted with a surface treatment solution containing fluorosilicic acid as a major ingredient, a porous structure was formed in the surface portion of the alkali-free glass.

FIG. 2 is graphs displaying secondary ion mass spectroscopy (SIMS) analysis results obtained from surface layers of alkali-free glass plates after the alkali-free glass plates are reacted with a surface treatment solution containing fluorosilicic acid as a major ingredient for different periods of time. In FIG. 2, the left graph represents the analysis result of the surface layer formed through the reaction performed for one minute, while the right graph represents the analysis result of the surface layer formed through the reaction performed for ten minutes. Referring to the analysis results, it can be appreciated that positive ions other than Si were gradually extracted from of the alkali-free glass with the lapse of reaction time, whereby the SiO₂ rich layers were formed in the surface portions of the alkali-free glass plates.

Finally, the heat treatment step is a step of heat-treating the surface-treated alkali-free glass, i.e. the alkali-free glass with the porous SiO₂ rich layer formed in the surface portion thereof. In the heat treatment step, the temperature at which the heat treatment is performed may be controlled to range from 500° C. to 1300° C. In the heat treatment step, only the porous SiO₂ rich layer formed in the surface portion of the alkali-free glass may be heat-treated to prevent the alkali-free glass from being deformed by a high-temperature heat treatment. To this end, for example, fire polishing or rapid thermal annealing (RTA) may be used.

When the alkali-free glass with the porous SiO₂ rich layer formed in the surface portion thereof is heat-treated as described above, the number of microscale pores in the porous SiO₂ rich layer shrink, thereby forming a uniform film or single film that is rich in SiO₂ in the surface portion of the alkali-free glass. When the heat treatment is continued, the SiO₂ rich single film and the mother alkali-free glass reach a thermal equilibrium.

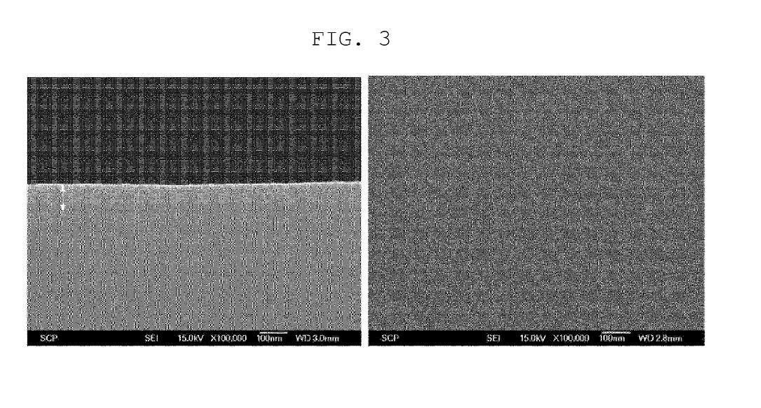

As an example of the present disclosure, an alkali-free glass plate that has undergone the surface treatment step was heat-treated at 950° C. for 30 minutes. After the completion of the heat treatment, an SEM image of the surface of the alkali-free glass was captured. The captured SEM image is provided in FIG. 3.

In the left image of FIG. 3, the arrow denotes the thickness direction of the porous SiO₂ rich layer. It can be appreciated that, when the alkali-free glass was heat-treated under the above-described conditions, the microscale pores in the porous SiO₂ rich layer shrank, whereby the porous SiO₂ rich layer was converted into the single or uniform SiO₂ rich layer.

In the heat treatment step, the alkali-free glass is cooled to room temperature to induce compressive stress in the surface of the alkali-free glass. When the alkali-free glass is cooled to room temperature, the SiO₂ rich layer, the CTE of which is lower than the mother alkali-free glass, shrinks less than the mother alkali-free glass, thereby causing a difference in stress therebetween. Due to the difference in stress between the inner portion and the outer portion of the alkali-free glass, i.e. between the inner portion and the SiO₂ rich layer of the alkali-free glass, compressive stress is generated in the surface portion of the alkali-free glass, i.e. the SiO₂ rich layer having the lower CTE, whereby the thin alkali-free glass plate is converted into toughened glass.

As set forth above, the method of manufacturing toughened glass according to some embodiments allows a toughened glass plate to be manufactured from a thin alkali-free glass plate that is difficult to toughen using a conventional thermal toughening method or a conventional chemical toughening method. Here, a porous SiO₂ rich layer, the CTE of which is lower than the inner portion of the alkali-free glass plate, is formed in the surface portion of the alkali-free glass plate through surface-treating the alkali-free glass plate using fluorosilicic acid, and then compressive stress is generated in the surface of the alkali-free glass plate based on the difference in the CTE between the surface and the inner portion of the alkali-free glass plate through heat-treating and then cooling the alkali-free glass plate, whereby the toughened glass plate is manufactured.

The foregoing descriptions of specific exemplary embodiments of the present disclosure have been presented with respect to the drawings. They are not intended to be exhaustive or to limit the present disclosure to the precise forms disclosed, and obviously many modifications and variations are possible for a person having ordinary skill in the art in light of the above teachings.

It is intended therefore that the scope of the present disclosure not be limited to the foregoing embodiments, but be defined by the Claims appended hereto and their equivalents.

1. A method of manufacturing toughened glass, the method comprising:
preparing alkali-free glass;
forming a porous SiO₂ rich layer in a surface portion of the alkali-free glass by surface-treating the alkali-free glass using a surface treatment solution comprising fluorosilicic acid, such that a coefficient of thermal expansion of the porous SiO₂ rich layer is lower than a coefficient of thermal expansion of an inner portion of the alkali-free glass; and
generating compressive stress in a surface of the alkali-free glass by heat-treating the surface-treated alkali-free glass.

2. The method of claim 1, wherein surface-treating the alkali-free glass comprises extracting positive ions other than Si from the alkali-free glass.

3. The method of claim 1, wherein the alkali-free glass comprises a thin alkali-free glass plate having a thickness of 2.0 mm or less.

4. The method of claim 1, wherein the surface treatment solution is prepared by supersaturating a 10 wt % to 50 wt % fluorosilicic acid water solution with SiO₂.

5. The method of claim 4, wherein KF or boric acid is added to the surface treatment solution.

6. The method of claim 1, wherein surface-treating the alkali-free glass is performed while controlling a temperature of the surface treatment solution in a range from room temperature to 55° C.

7. The method of claim 1, wherein heat-treating the surface-treated alkali-free glass is performed at a temperature in a range from 500° C. to 1300° C.

8. The method of claim 1, wherein preparing the alkali-free glass comprises cleaning the surface of the alkali-free glass using an HF water solution.
